(19) United States
(12) Patent Application Publication
(10) Pub. No.: US 2021/0362460 A1
(43) Pub. Date: Nov. 25, 2021

(54) VACUUM INSULATION ELEMENT FOR USE AS A PRESSURE- AND IMPACT-RESISTANT, SELF-SUPPORTING ELEMENT

(71) Applicant: va-Q-tec AG, Wuerzburg (DE)

(72) Inventors: Tobias Bock, Kitzingen (DE); Roland Caps, Kleinwallstadt (DE); Hendrik Feuerstein, Wuerzburg (DE); Jasper Laug, Wuerzburg (DE)

(21) Appl. No.: 17/323,536

(22) Filed: May 18, 2021

(30) Foreign Application Priority Data
May 20, 2020 (DE) 10 2020 113 630.7

(51) Int. Cl. B32B 3/04; B32B 5/02; B32B 37/14; B32B 9/00; B32B 9/04

(52) U.S. Cl. CPC B32B 3/04; B32B 5/02; B32B 37/142; B32B 9/005; B32B 9/047; B32B 2262/106; B32B 2307/558; B32B 2260/021; B32B 2260/046; B32B 2262/101; B32B 2262/0269; B32B 2307/304

(57) ABSTRACT

The present invention relates to a vacuum insulation element for use as a pressure- and impact-resistant, self-supporting element comprising a supporting body and a foil casing surrounding the supporting body, and wherein the foil casing, at least in sections, comprises a fiber composite material.

### CROSS-REFERENCE TO RELATED APPLICATIONS

This patent application claims priority to German utility patent application number 10 2020 113 630.7 filed May 20, 2020 and titled “vacuum insulation element for use as a pressure- and impact-resistant, self-supporting element”. The subject matter of patent application number 10 2020 113 630.7 is hereby incorporated by reference in its entirety.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### BACKGROUND

The present invention relates to the technical field of vacuum insulation elements, such as vacuum insulation panels (VIP) for thermal insulation, which are applied in a wide variety of technical fields, such as aviation and aerospace industries, mechanical engineering and plant construction industry, automotive industry, medical engineering industry or the chemical industry.

In conventional vacuum insulation panels, a core material is encased with a high-barrier foil and evacuated to a negative pressure. Due to the negative pressure built up inside the vacuum insulation panel, the high-barrier foil exerts a force against the core material, which compresses, respectively compacts the core material. The strength of the vacuum insulation panel results from the increase in internal frictional forces in the core material caused by the compression or compaction. These frictional forces counteract external forces to provide in this way a self-supporting component that can be installed without changing its external shape, e.g. buckling or sagging.

Regarding strength of the vacuum insulation panel achieved in this way, not only the power of the negative pressure generated, but also the shape of the vacuum insulation panel as well as the composition of the core material are crucial.

A problem concerning the mechanical strength of the vacuum insulation panel, for example, is a decreasing thickness, the use of a core material with low internal friction or the reduced negative pressure in connection with longer service life. In this context, the vacuum insulation panel is likely to deform undesirably even under minor external forces.

Another drawback with conventional vacuum insulation panels is that stability in terms of impact resistance is frequently insufficient to reduce permanent deformations in the event of impacts against the high-barrier foil.

Another drawback with conventional vacuum insulation panels is that there is no protection against damage to the high-barrier foil resulting from mechanical and thermal effects or chemicals, whereby negative pressure in the vacuum insulation panel is impaired as a result of such damage.

Vacuum insulation panels of this type also involve drawbacks with respect to fire resistance, which have been overcome in part by the feature that the barrier foil comprises a glass fiber material to increase temperature resistance.

### SUMMARY

The present invention relates to a vacuum insulation element for use as a pressure- and impact-resistant, self-supporting element according to the independent claim.

It is the object of the present invention to provide a vacuum insulation element as well as a method of manufacturing a vacuum insulation element, which overcome the drawbacks associated with prior art and which vacuum insulation element features, in particular, stable mechanical properties.

The present invention encompasses a vacuum insulation element (such as a vacuum insulation plate) for use as a pressure- and impact-resistant, self-supporting element comprising a supporting body (such as fumed silica, microfiber materials, perlites or open-pored plastic foams) and a foil casing (such as a metallized plastic foil) surrounding the supporting body. In this regard, the foil casing, at least in sections, comprises a fiber composite material. The fiber composite material is a mixed material (fiber-reinforced plastic) including reinforcing fibers embedded in a “matrix” (filler and adhesive). The fiber composite material, for example, can be applied without pressure and at ambient temperature or under pressure, also tension during winding, and heat onto the foil casing. The application can also be realized at ambient temperature with pressure or at a higher temperature without pressure. In this regard, the fibers and the matrix are selected so as to stabilize the vacuum insulation element in such a way that the resulting vacuum insulation element exhibits an exoskeleton of fiber composite material. In this way, the static and mechanical properties are optimized. In particular in applications, where the vacuum insulation element is subjected to high mechanical or thermal stresses and only small wall thicknesses are required, the vacuum insulation element can be used in the self-supporting fashion.

### BRIEF DESCRIPTION OF THE DRAWINGS

FIG. 1 shows a schematic top view of a first vacuum insulation element;

FIG. 2 shows a schematic sectional view of the first vacuum insulation element of FIG. 1;

FIG. 3 shows a schematic top view of a second vacuum insulation element;

FIG. 4 shows a schematic sectional view of the second vacuum insulation element of FIG. 3;

FIG. 5 shows a schematic top view of a third vacuum insulation element; and

FIG. 6 shows a schematic sectional view of the third vacuum insulation element of FIG. 5.

### DETAILED DESCRIPTION

According to a preferred aspect, the fiber composite material comprises thermosetting, elastomeric and/or thermoplastic materials. The fiber composite material, for example, can be pre-impregnated with thermosetting and/or thermoplastic materials in a prepreg process. The exoskeleton can be adapted to specific applications by appropriately selecting the fabric structure and the thermosetting or thermoplastic materials used.

According to another preferred aspect, the thermosetting and/or thermoplastic materials include phenolic, epoxy, polyimide or silicone resin, cyanate esters or combinations thereof.

According to a particularly preferred aspect, the fiber composite material comprises reinforcing fibers of glass, aramide or carbon fibers. The fiber composite material can be designed in the form of rovings, filaments, hybrid yarns, woven fabrics, interlaid scrims, warp-knitted fabrics, knitted fabrics or non-woven fabrics. The fiber composite material may be selected with respect to resistance to mechanical and thermal effects or chemicals.

According to an advantageous aspect, the fiber composite material is designed to completely surround the foil casing. This makes it possible to realize comprehensive protection against damage to the foil casing by mechanical and thermal effects or chemicals. In this context, several vacuum insulation elements can be laminated together, whereby, for example, a hinge element can be formed or incorporated.

According to a particularly advantageous aspect, the foil casing comprises a sealed seam. In this regard, the sealed seam is folded so as to rest against the supporting body. The sealed seam can be formed by thermal welding. Thereby, the sealed seam can project beyond the supporting body.

According to a preferred aspect, the vacuum insulation panel includes a recess. Thereby, the foil casing and/or the fiber composite material can straddle the recess.

According to another preferred aspect, the fiber composite material includes an edge portion. In this context, the edge portion is designed to protrude from an edge of the vacuum insulation panel by at least 2 mm.

According to a particularly preferred aspect, threads, metal elements, magnets, retainers and/or hinges are incorporated into the fiber composite material.

The invention encompasses a method of manufacturing a vacuum insulation element according to any one of the preceding claims, comprising the following steps of: providing a vacuum insulation element comprising a supporting body (step A); and encasing the supporting body with a foil casing comprising a fiber composite material (step B).

According to an advantageous aspect, the step of encasing the supporting body comprises encasing the supporting body with a foil casing and applying a fiber composite material onto the foil casing.

According to a further advantageous aspect, the step of encasing the supporting body comprises complete and/or partial encasing thereof. This makes it possible to achieve protection against damage to the foil casing by mechanical effects or chemicals.

According to a particularly advantageous aspect, the application of the fiber composite material is carried out by means of manual lamination or fiber spraying or winding or prepreg technology or resin transfer molding.

According to a preferred aspect, the application of the fiber composite material is carried out without pressure and at ambient temperature or under pressure and heat. The application is also possible at ambient temperature with pressure or at a higher temperature without pressure.

In the following, the invention will be explained in more detail using the examples shown in the attached drawings. Identical reference signs refer to identical features in all figures.

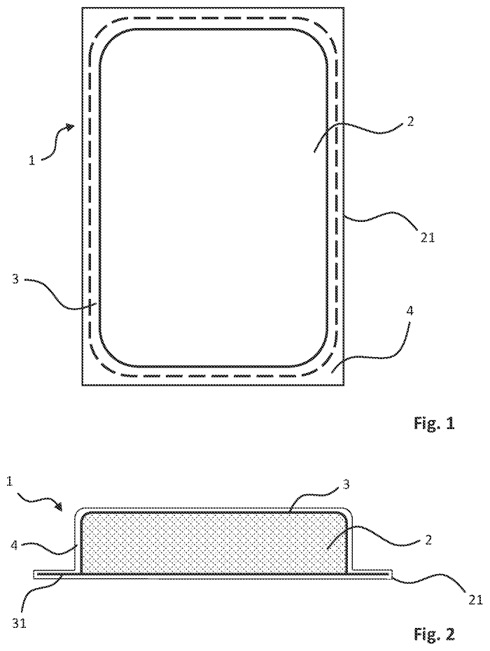

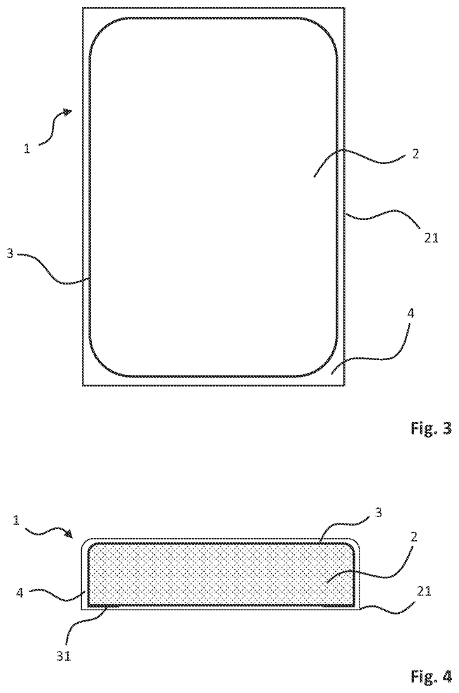

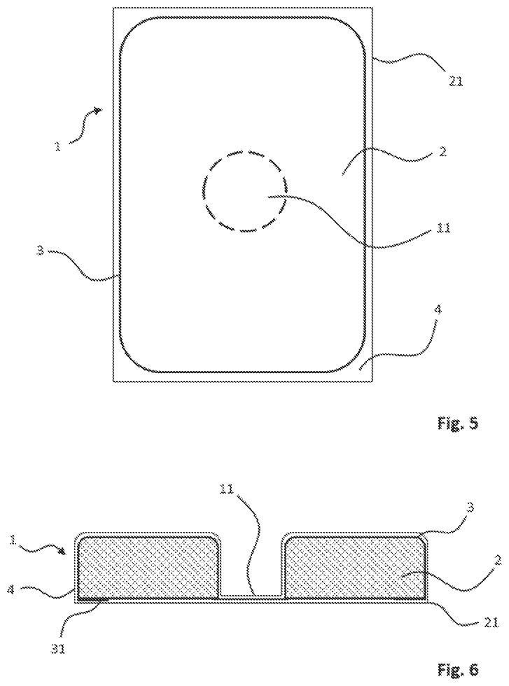

FIG. 1, FIG. 3 and FIG. 5 each show a schematic top view of a first, second and third vacuum insulation element 1 and FIG. 2, FIG. 4 and FIG. 6 each show a schematic sectional view of the first, second and third vacuum insulation element 1.

The vacuum insulation element 1 shown in each case is designed as a vacuum insulation panel and is particularly suitable for use as a pressure-resistant and impact-resistant, self-supporting element. In this regard, the vacuum insulation element 1 comprises a supporting body 2 and a foil casing 3 surrounding the supporting body 2. In the examples shown, the supporting body 2 is formed from fumed silica and the foil casing 3 is formed from a metallized plastic foil.

The foil casing 3 comprises a fiber composite material 4 which completely surrounds the foil casing. This makes it possible to realize particularly effective protection against damage to the foil casing by mechanical and thermal effects or chemicals.

The fiber composite material 4 is designed as a woven fabric comprising reinforcing aramide fibers and is particularly suitable in terms of resistance to mechanical effects.

The fiber composite material 4 was applied onto the foil casing 3 under pressure and heat. Here, the fiber composite material 4 comprises thermosetting and thermoplastic materials, which were pre-impregnated in a prepreg process.

The fiber composite material 2 comprises an edge portion 21, which edge portion 21 is formed to protrude from an edge of the vacuum insulation panel by at least 2 mm.

The foil casing 3 comprises a sealed seam 31 which is folded so as to rest against the supporting body 2. Here, the sealed seam 31 is formed by thermal welding.

The sealed seam 31 shown in FIG. 1 and FIG. 2 projects beyond the supporting body 2.

The sealed seam 31 shown in FIG. 3, FIG. 4, FIG. 5 and FIG. 6 does not project beyond the supporting body 2.

The vacuum insulation element 1 shown in FIG. 5 and FIG. 6 comprises a recess 11, wherein the foil casing 3 and the fiber composite material 4 straddle the recess 11.

What is claimed is:

1. Vacuum insulation element for use as a pressure- and impact-resistant, self-supporting element comprising a supporting body and a foil casing surrounding the supporting body, and wherein the foil casing, at least in sections, comprises a fiber composite material.

2. Vacuum insulation element according to claim 1, wherein the fiber composite material comprises thermosetting, elastomeric and/or thermoplastic materials.

3. Vacuum insulation element according to claim 2, wherein the thermosetting and/or thermoplastic materials include phenolic, epoxy, polyimide or silicone resin, cyanate esters or combinations thereof.

4. Vacuum insulation element according to claim 1, wherein the fiber composite material comprises reinforcing fibers of glass, aramide and/or carbon fibers.

5. Vacuum insulation element according to claim 1, wherein the fiber composite material is designed to completely surround the foil casing.

6. Vacuum insulation element according to claim 1, wherein the vacuum insulation element is a vacuum insulation panel.

7. Vacuum insulation element according to claim 6, wherein the foil casing comprises a sealed seam, and wherein the sealed seam is folded so as to rest against the supporting body.

8. Vacuum insulation element according to claim 6, wherein the vacuum insulation panel includes a recess.

9. Vacuum insulation element according to claim 6, wherein the fiber composite material comprises an edge portion, and wherein the edge portion is designed to protrude from an edge of the vacuum insulation panel by at least 2 mm.

10. Vacuum insulation element according to claim 1, wherein threads, metal elements, magnets, retainers and/or hinges are incorporated in the fiber composite material.

11. Method of manufacturing a vacuum insulation element according to claim 1, comprising the following steps of:
providing a vacuum insulation element comprising a supporting body (step A); and
encasing the supporting body with a foil casing comprising a fiber composite material (step B).

12. Method of claim 11, wherein the step of encasing the supporting body comprises encasing the supporting body with a foil casing and applying a fiber composite material onto the foil casing.

13. Method according to claim 11, wherein the step of encasing the supporting body includes complete and/or partial encasing thereof.

14. Method according to claim 11, wherein the application of the fiber composite material is carried out by means of manual lamination or spraying or winding or prepreg technology or resin transfer molding.

15. Method according to claim 11, wherein the application of the fiber composite material is carried out without pressure and at ambient temperature, under pressure and heat, or without pressure under heat.
